(19) United States
(12) Patent Application Publication
(10) Pub. No.: US 2018/0098654 A1
(43) Pub. Date: Apr. 12, 2018

(54) DRYING CLIP

(71) Applicants: Greta Larson, Afton, MN (US); John Anthony DePaola, Jackson, NJ (US)

(72) Inventors: Greta Larson, Afton, MN (US); John Anthony DePaola, Jackson, NJ (US)

(21) Appl. No.: 15/499,772

(22) Filed: Apr. 27, 2017

Related U.S. Application Data
(60) Provisional application No. 62/328,126, filed on Apr. 27, 2016.

(51) Int. Cl. A47G 29/08; F16B 2/22

(52) U.S. Cl. CPC A47G 29/08; F16B 2/22

(57) ABSTRACT

A drying clip for hanging articles from a member having a cross-sectional dimension, particularly a water faucet spout, the drying clip including a grasping portion forming an arc with a first end and a second end, and an opening between the ends, the opening having a dimension less than the cross-sectional dimension of the member; a first arm extending from the grasping portion; and, a second arm extending from said grasping portion. When the grasping portion is fitted around the member, the member supports the drying clip and articles hung from the first and second arms thereof. The first end and the second end may include terminus members angled outwardly to facilitate widening of the opening upon exertion of pressure thereon. The drying clip may include a flange extending along the grasping portion for stiffening the grasping portion.

### CROSS-REFERENCE TO RELATED APPLICATIONS

The present application claims benefit of U.S. Provisional Patent Application Ser. No. 62/328,126, filed Apr. 27, 2016, entitled “Device/Clip On Faucet For The Ability To Allow Something To Hang Dry Over A Sink,” the disclosure of which is hereby incorporated by reference herein.

### BACKGROUND OF THE INVENTION

The present invention relates to the hanging of articles, for example articles of manufacture, primarily for the purpose of drying. While such articles may include virtually any article, including tools, textiles, sponges, scrub brushes, footwear, and the like, the focus herein will be on paintbrushes.

Most manufacturers of paintbrushes have recommended guidelines or procedures for cleaning and properly caring for a paintbrush following its use. Indeed, these guidelines or procedures often come printed on the paintbrush package itself. While the actual cleaning procedures may differ depending on the paint or stain having been used, for example whether it is oil or water based, most manufacturers recommend hanging the paintbrush to air dry after cleaning. Only after complete drying should the paintbrush be returned to its original package. This helps to maintain bristle integrity and shape.

### BRIEF SUMMARY OF THE INVENTION

Despite the recommendation to hang a paintbrush for drying, to date there have been no completely suitable, simple, and clean solutions for hanging a brush. As such, a device to hang paintbrushes to dry is presented herein.

In accordance with one embodiment of the invention, the invention provides for a drying clip for hanging articles from a member having a cross-sectional dimension, where the drying clip includes a grasping portion forming an arc with a first end and a second end, and an opening between the ends, the opening having a dimension less than the cross-sectional dimension of the member; a first arm extending from the grasping portion; a second arm extending from the grasping portion; wherein, when the grasping portion is fitted around the member, the member supports the drying clip and articles hung from the first and second arms thereof.

The member may have a circular cross-section.

The member may be a spout of a water faucet.

The articles may be paint brushes.

The drying clip may be unitarily formed.

The arc may be of constant radius.

The grasping portion may be resilient.

The first end and the second end may include terminus members angled outwardly to facilitate widening of the opening upon exertion of pressure thereon.

The first arm may extend from the grasping portion with a linear extension area thereof, the linear extension area extending to an inflection point.

The dimension of the opening may be less than 18 mm.

The drying clip may further comprise a flange extending along at least some portion of the grasping portion, first arm, and second arm, the flange providing strength for stiffening the drying clip.

The first end and the second end may include terminus members angled outwardly to facilitate widening of the opening upon exertion of pressure thereon, and the drying clip may further include a flange extending along at least some portion of the grasping portion, first arm, arid second arm, the flange providing strength for stiffening the drying clip.

In accordance with a further embodiment of the present invention, a clip for attaching to a member with a circular cross-section is provided, the clip including a resilient grasping portion having an opening, the resilient grasping portion having a minor dimension; and a first arm and a second arm extending from the grasping portion in opposite directions from one another; wherein the opening of the resilient grasping portion may be spread apart to expand the minor dimension to fit over the member, and subsequently released to resiliently impart pressure upon the member, thereby attaching the clip to the member.

The minor dimension may be less than the diameter of the circular cross-section of the member.

The clip may further include a flange extending along the grasping portion for stiffening the grasping portion.

The clip may further include a flange extending along at least some portion of the resilient grasping portion, the first arm, and the second arm, for stiffening the drying clip.

In a still further embodiment of the invention, a kit of components may include at least one paint brush; at least one drying clip, each of the at least one drying clips comprising a grasping portion forming an arc with a first end and a second end, and an opening between the ends; a first arm extending from the grasping portion; a second arm extending from the grasping portion; wherein the grasping portion of one of the at least one drying clip may be fitted around a member to support the one of the at least one drying clip and at least one of the at least one paint brush may be hung from at least one of the first arm and the second arm.

Each of the at least one drying clips may further include a strengthening flange.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof, will be or become apparent to one with skill in the art upon reference to the following detailed description when read with the accompanying drawings. It is intended that any additional organizations, methods of operation, features, objects or advantages ascertained by one skilled in the art be included within this description, be within the scope of the present invention, and be protected by the accompanying claims.

With respect to the drawings, FIG. 1 shows a frontal perspective view of a drying clip in accordance with a first embodiment of the present invention;

FIG. 2 shows a front view of the drying clip of FIG. 1;

FIG. 3 shows a side view of the drying clip of FIG. 1, the other side view being a mirror image;

FIG. 4 shows a top view of the drying clip of FIG. 1;

FIG. 5 shows a bottom view of the drying clip of FIG. 1;

FIG. 6 shows a front view of a drying clip in accordance with a second embodiment of the present invention;

FIG. 7 shows a frontal perspective view of the drying clip of FIG. 6; and,

FIG. 8 shows a drying clip in use, mounted on the spout of a water faucet, and hanging paint brushes.

### DETAILED DESCRIPTION

In the following are described the preferred embodiments of the DRYING CLIP in accordance with the present invention. In describing the embodiments illustrated in the drawings, specific terminology will be used for the sake of clarity. However, the invention is not intended to be limited to the specific terms so selected, and it is to be understood that each specific term includes all technical equivalents that operate in a similar manner

to accomplish a similar purpose. Where like elements nave been depicted in multiple embodiments, identical reference numerals have been used in the multiple embodiments for ease of understanding.

FIG. 1 depicts a frontal perspective view of a drying clip 100 in accordance with a first, and preferred, embodiment of the present invention. The drying clip 100 may be configured from a variety of materials, including various plastics and metals. Preferred materials include polypropylene that may be molded in a mold. Regardless of the material, it is preferred that the drying clip 100 be resilient, such that it will recoil or spring back into shape after being bent, stretched, or compressed.

As shown in FIG. 1, the drying clip 100 is preferably a unitary piece, such as one formed monolithically within a mold. The drying clip 100 comprises a predominantly annular central portion 102 with two arms 104, 106 extending in opposite directions therefrom. Preferably this extension is along a single plane.

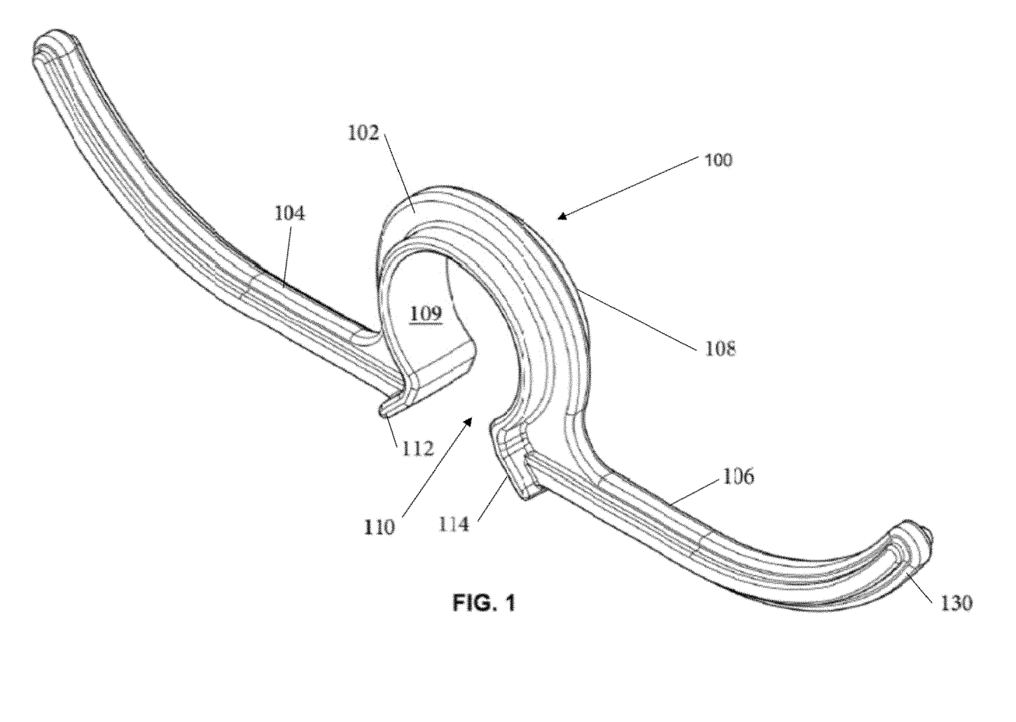

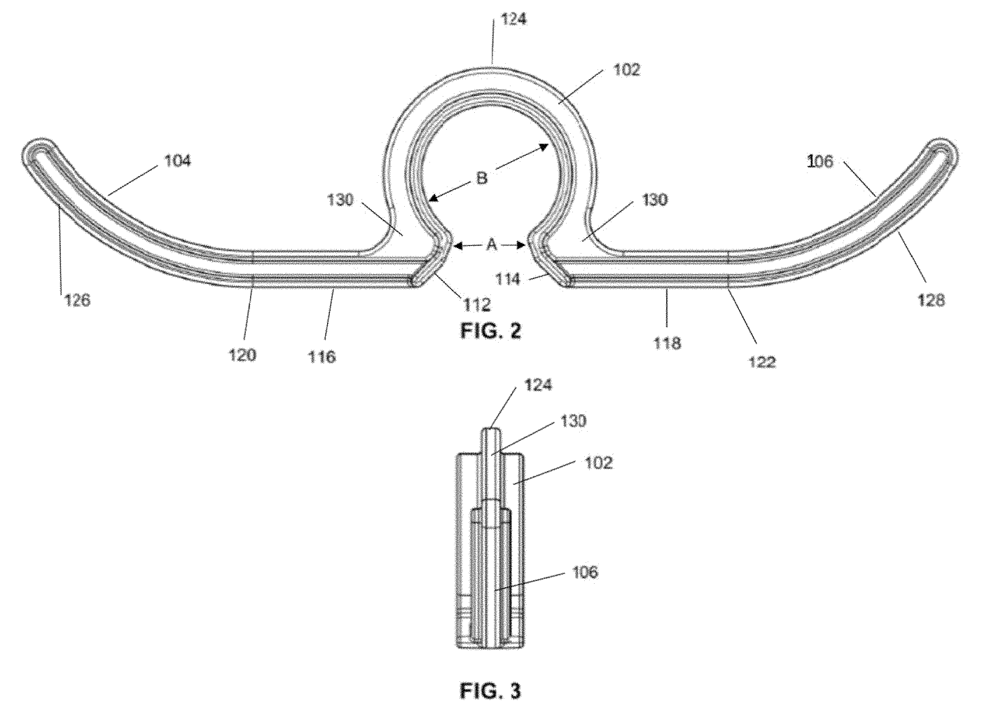

A grasping portion 108 is formed within the central portion 102 as a constant radius arc having a length greater than that of a semi-circle. This grasping portion 108 preferably spans approximately 315°, leaving an opening 110 of approximately 45°. In other embodiments, the grasping portion 108 may span greater or less than 315°, with preferred embodiments leaving an opening 110 having an opening distance “A” less than the diameter “B” of the grasping portion 108 (see FIG. 2). In other embodiments, the grasping portion 108 may he other than a constant radius arc.

As will be discussed below, in preferred embodiments, the diameter “B” of the grasping portion 108 is less than the spout diameter of a conventional water faucet upon which the drying clip 100 will be placed, thus requiring the grasping portion 108 to be spread apart, temporarily lengthening the opening distance “A” (i.e. widening the opening), when fitted over a water faucet spout. In other embodiments where the grasping portion 108 may foe other than a constant radius arc, the “S” dimension is generally to be construed as the minor, or shortest dimension, across the grasping portion.

In the preferred embodiment, the “B” dimension is 18 mm. In other embodiments, the dimension may be less than 18 mm or greater than 18 mm, with preference to the dimensions of or between approximately 12 mm and 30 mm.

The inside surface 109 of the grasping portion is shown as being smooth, but it may be textured or otherwise treated, such as with an additional component, to increase friction between the inside surface 109 and the member upon which it is mounted.

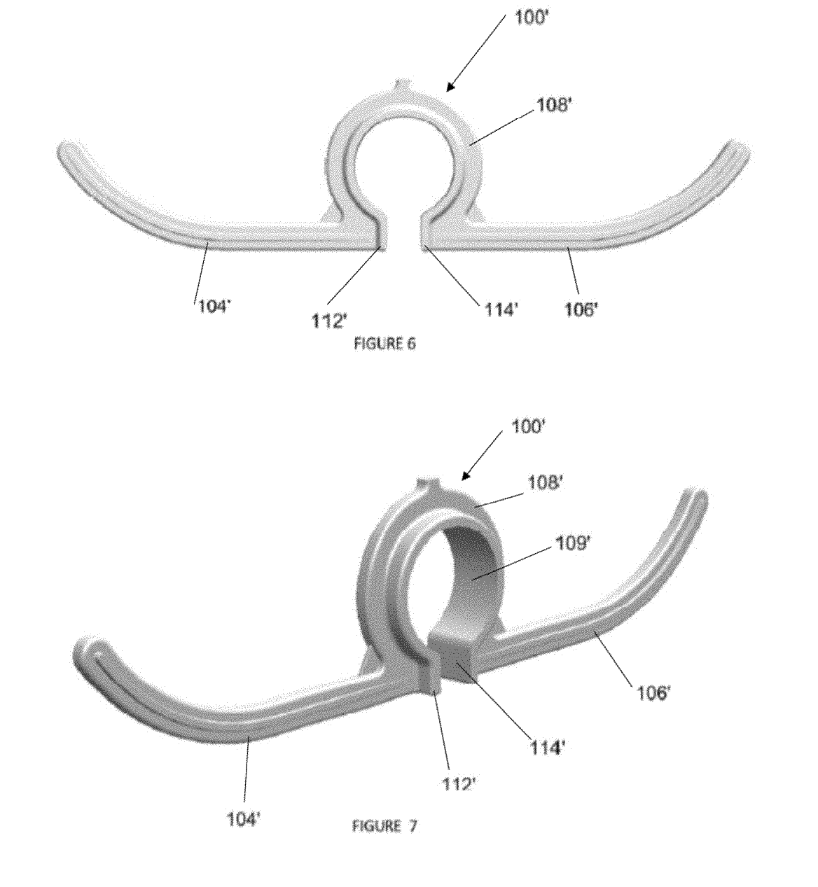

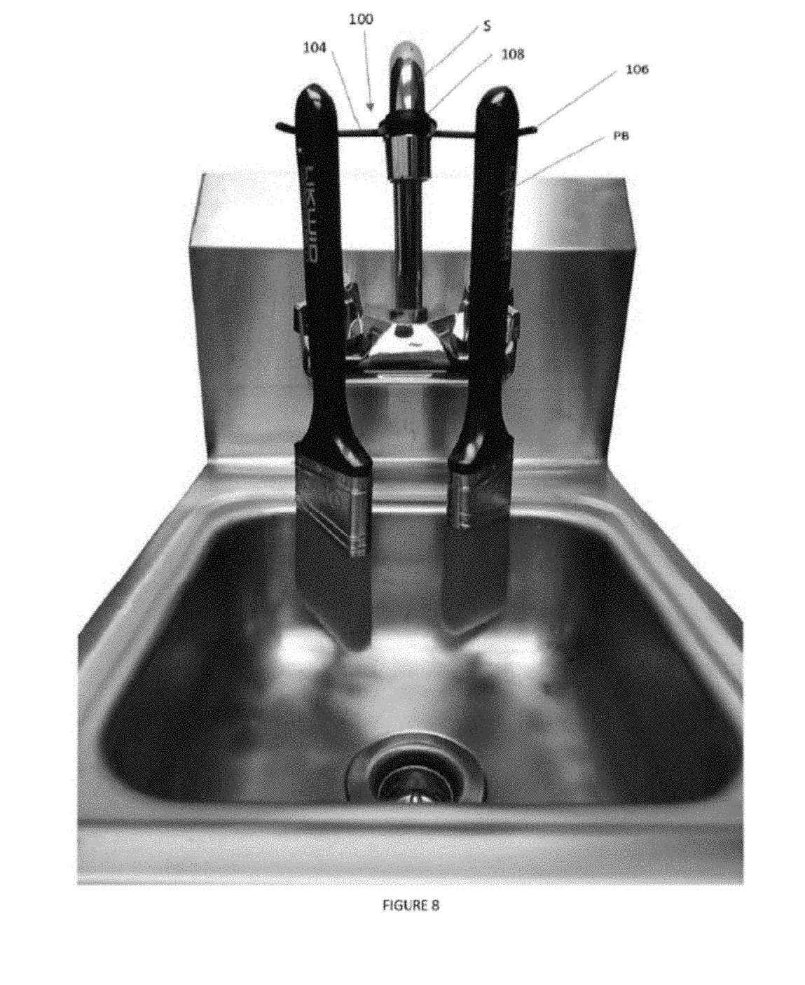

Defining the opening 110 of the central portion 102 are terminus members 112, 114. In the embodiment shown in FIG. 1, the terminus members 112, 114 are each angled outwardly from a direction within the central portion 102. In other embodiments, for example the embodiment of the invention shown in FIGS. 6-7, the terminus members 112′, 114′ may be parallel to each other. By being angled outwardly, the terminus members 112,, 114 may be abutted and pushed against a spout of a conventional water faucet, thus forcing the opening “A” to increase in length due to pressure upon, and cam action of, the angled terminus members. In preferred embodiments, at least the grasping portion 108 is resilient so the opening “A” returns back to, or near to, its original length after mounting of the drying clip 100 on the spout.

As previously mentioned, the drying clip 100 includes two arms 104, 106 extending from the central portion 102 in opposite directions. Specifically, in the embodiment shown in FIG. 1, the arms extend from the grasping portion 103 starting in the general area of the terminus members 112, 114, respectively, along a single plane.

Each arm 104, 106 initially extends parallel to one another in respective linear extension areas 116, 118 until they reach inflection points 120, 122, and begin to bend in a direction, in the preferred embodiment, toward the head portion 124 of the grasping member 108, defined as that portion opposite the opening 110. Beyond the inflection points 120, 122 are respective curved portions 126, 128 of the arms 104, 106. In other embodiments the arms 104, 106 may take on different geometric configurations.

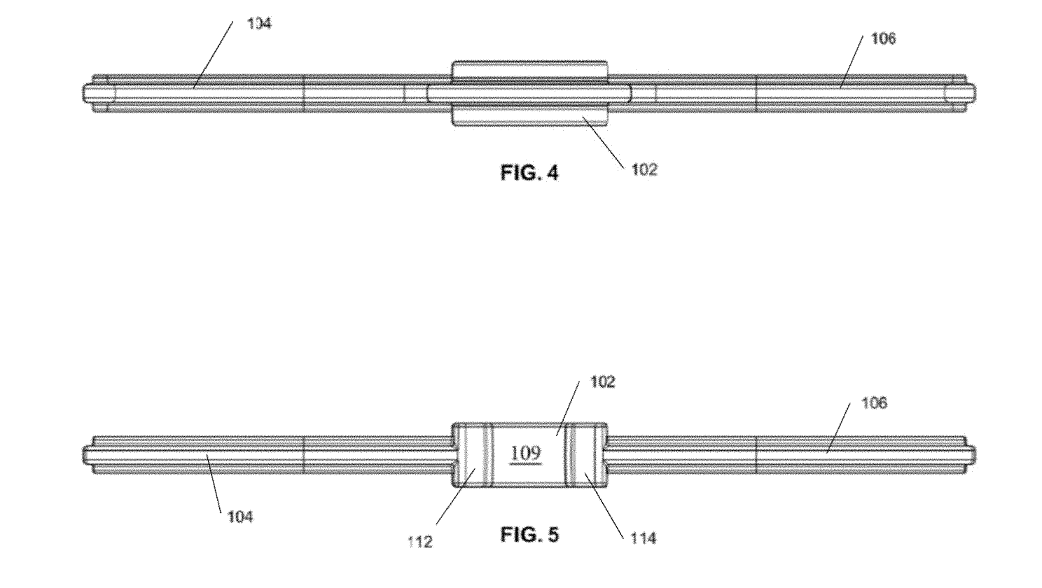

Although not required, in the embodiment of the drying clip 100 shown in FIGS. 1-5, the drying clip includes a continuous flange 130 extending around the annular central portion 102 and two arms 104, 106. This continuous flange 130 provides additional material to the clip and offers strength for stiffening the arms 104, 106 in particular, although it also stiffens the grasping portion 108 of the annular central portion 102. In other embodiments the flange may only be provided along one or more portions of the grasping portion and arms and not the entire clip. In preferred embodiments, the flange 130 forms a “cross-shaped” cross-section with the arms 104, 106 of the clip.

As previously discussed, FIGS. 6 and 7 show a drying clip 100′in accordance with a second embodiment of the present invention. The primary difference between the drying clip 100′ of this embodiment and that of the embodiment shown in FIGS. 1-5 are the arrangement of the terminus members 112′, 114′ being parallel to each other. In this regard, in order to install the drying clip 100′ over a water faucet spout, one much manually spread the terminus members 112′, 114′ apart to enlarge the distance between them.

For completeness, it is noted that the drying clip 100′ also includes a grasping portion 108′ positioned between a pair of arms 104′, 106′, where the grasping portion has an inner surface 109′. Also provided is a flange 130′ extending around the grasping portion 108′ and the arms 104′, 106′. In this particular embodiment, it will be appreciated that the flange 130′ is not as pronounced in the arm area 104′, 106′ as in the area of the grasping portion 108′.

FIG. 8 shows an example of a drying clip 100 in use, mounted on the spout “S” of a water faucet, and hanging paint brushes “PB” from the arms 104, 106. In order to achieve this, the drying clip 100 is fitted over the spout “S” by spreading the grasping portion 108, fitting it over the spout, and then allowing it to rebound back to position fixed upon the spout. This automatically positions the arias outwardly as shown in FIG. 8. It will be appreciated that in this scenario the drying clip 100 is resilient. If non-resilient, the grasping portion may have to be manually returned to its smaller diameter size.

Paint brushes “PB,” and specifically apertures formed in their handles, may then be threaded through the arms 104, 106 respectively to hang the paint brushes for drying. While hanging, water trapped in the bristles of the paint brushes “PB” is permitted to drip into a sink. Notably, the curvature of the arms 104, 106 aids in preventing the paint brushes “PB” from sliding off the arms, as they might if the arms were completely linear.

Although reference has been made to water faucets and their spouts, the drying clips shown and described herein can be fitted over other members, preferably those having circular cross-sections, such as pipes, conduits, and the like.

Although the invention herein has been described with reference to particular embodiments, it is to be understood that these embodiments are illustrative of the principles and applications of the present invention. It is therefore to be understood that numerous modifications may be made to the illustrative embodiments and that other arrangements may be devised without departing from the spirit and scope of the present invention as defined by the appended claims.

We claim:

1. A drying clip for hanging articles from a member having a cross-sectional dimension, said drying clip comprising:
a grasping portion forming an arc with a first end and a second end, and an opening between said ends, said opening having a dimension less than the cross-sectional dimension of the member;
a first arm extending from said grasping portion;
a second arm extending from said grasping portion;
wherein, when said grasping portion is fitted around the member, the member supports the drying clip and articles hung from the first and second arms thereof.

2. The drying clip of claim 1, wherein said member has circular cross-section.

3. The drying clip of claim 1, wherein said member is a spout of a water faucet.

4. The drying clip of claim 1, wherein said articles are paint brushes.

5. The drying clip of claim 1, wherein said drying clip is unitarily formed.

6. The drying clip of claim 1, wherein said arc is of constant radius.

7. The drying clip of claim 1, wherein said grasping portion is resilient.

8. The drying clip oi claim wherein said first end and said second end include terminus members angled outwardly to facilitate widening of said opening upon exertion of pressure thereon.

9. The drying clip of claim 1, wherein said first arm extends from said grasping portion with a linear extension area thereof, said linear extension area extending to an inflection point.

10. The drying clip of claim 1, wherein said dimension of said Opening is less than 18 mm.

11. The drying clip of claim 1, further comprising a flange extending along at least some portion of said grasping portion, first arm, and second arm, said flange providing strength for stiffening the drying clip.

12. The drying clip of claim 8, further comprising a flange extending along at least some portion of said grasping portion, first arm, and second arm, said flange providing strength for stiffening the drying clip.

13. A clip for attaching to a member with a circular cross-section, said clip comprising:
a resilient grasping portion having an opening, said resilient grasping portion having a minor dimension;
a first arm and a second arm extending from said grasping portion in opposite directions from one another;
wherein said opening of said resilient grasping portion may be spread apart to expand said minor dimension to fit over the member, and subsequently released to resiliently impart pressure upon the member, thereby attaching the clip to the member.

14. The clip of claim 13, wherein said minor dimension is less than the diameter of the circular cross-section of the member.

15. The clip of claim 13, further comprising a flange extending along said grasping portion for stiffening the grasping portion.

16. The clip of claim 13, further comprising a flange extending along at least some portion of said resilient grasping portion, said first arm, and said second arm, for stiffening the drying clip.

17. A kit of components, said kit comprising: at least one paint brush;
at least one drying clip, each of said at least one drying clip comprising:
a grasping portion forming an arc with a first end and a second end, and an opening between said ends;
a first arm extending from said grasping portion;
a second arm extending from said grasping portion;
wherein said grasping portion of one of said at least one drying clip may be fitted around a member to support said one of said at least one drying clip and at least one of said at least one paint brush may be hung from at least one of said first arm and said second arm.

18. The kit of claim 17, wherein each of said at least one drying clips further comprises a strengthening flange.
